(19) United States
(12) Patent Application Publication
(10) Pub. No.: US 2022/0253603 A1
(43) Pub. Date: Aug. 11, 2022

(54) E-MAIL CLASSIFICATION DEVICE, E-MAIL CLASSIFICATION METHOD, AND COMPUTER PROGRAM

(71) Applicant: A&B COMPUTER CORPORATION, Tokyo (JP)

(72) Inventors: Kouichi CHIBA, Tokyo (JP); Yoshiharu KOUJI, Tokyo (JP)

(21) Appl. No.: 17/422,281

(22) PCT Filed: Nov. 26, 2019
(86) PCT No.: PCT/JP2019/046215

§ 371 Date: Feb. 16, 2022

(30) Foreign Application Priority Data
Nov. 26, 2018 (JP) 2018-220263

(51) Int. Cl. G06F 40/279; G06F 16/35

(52) U.S. Cl. CPC G06F 40/279; G06F 16/353

(57) ABSTRACT

A mail sorting device includes: a storage unit that inputs text data of a sorting-target mail and at least temporarily stores the text data; a discrimination data table that stores morphemes that can be contained in text data of a mail for every part of speech; an analysis unit that refers to the discrimination data table, and identifies which morpheme, among the morphemes stored in the discrimination data table, is contained in the sorting-target mail; a data conversion unit that, based on a result of a processing operation performed by the analysis unit, generates an image for determination that represents distribution of morphemes contained in the sorting-target mail, among the morphemes stored in the discrimination data table; and a sorting determination unit that determines in which category the sorting-target mail should be sorted, based on a learned model that has learned a correlation between an image for determination and a sorting-target mail category.

### TECHNICAL FIELD

The present invention relates to a mail sorting device for sorting a mail automatically.

### BACKGROUND ART

A variety of techniques have conventionally been proposed for appropriately sorting Emails arriving in bulk every day according to a desired purpose. For example, Patent Document 1 (JP-A-2013-105226) discloses a received mail sorting device that automatically sorts a received mail that answers a question sentence contained in a sent mail. In this sorting device, a keyword (question sentence) is identified in sentences contained in a sent mail, a sentence following a quotation mark is extracted from a received mail, and whether the keyword (question sentence) is contained in the extracted sentence is determined, whereby an answering mail is extracted.

A technique for sorting mails depending on whether a specific keyword is contained in the subject or the body of the mail has conventionally been used widely, too, particularly in the detection of junk mails.

### SUMMARY

Sorting in accordance with a keyword, however, involves a problem that it is difficult to obtain an appropriate sorting result unless the keyword is set elaborately. Besides, recently, as using artificial intelligence (AI) has become practically possible, sorting mails in accordance with a word contained in a mail with use of a learned model utilizing a neural network is expected as an area to which AI is applied.

It is an object of the present invention to provide a mail sorting device, a mail sorting method, and a computer program that is capable of appropriately sorting a mail in any of a plurality of categories, with use of a learned model utilizing a neural network.

To achieve the above-described object, the mail sorting device of the present invention includes:
a storage unit that inputs text data of a sorting-target mail and at least temporarily stores the text data;
a discrimination data table that stores morphemes that can be contained in text data of a mail for every part of speech;
an analysis unit that refers to the discrimination data table, and identifies which morpheme, among the morphemes stored in the discrimination data table, is contained in the sorting-target mail;
a data conversion unit that, based on a result of a processing operation performed by the analysis unit, generates an image for determination that represents distribution of morphemes contained in the sorting-target mail, among the morphemes stored in the discrimination data table; and
a sorting determination unit that determines in which category the sorting-target mail is to be sorted, based on a learned model that has learned a correlation between an image for determination and a sorting-target mail category.

With the present invention, it is possible to provide a mail sorting device, a mail sorting method, and a computer program that is capable of appropriately sorting a mail in a plurality of categories, with use of a learned model utilizing a neural network.

### BRIEF DESCRIPTION OF DRAWINGS

FIG. 1 is a block diagram illustrating a schematic configuration of a mail sorting system according to one embodiment of the present invention.

FIG. 2 illustrates exemplary sorting-learning data.

FIG. 3 illustrates an exemplary result of analysis of the sorting-learning data shown in FIG. 2 by a morpheme analysis unit.

FIG. 4A illustrates an exemplary discrimination data table composed of feature data.

FIG. 4B illustrates an exemplary discrimination data table composed of feature data, continued from FIG. 4A.

FIG. 5A illustrates an exemplary sorting-target mail.

FIG. 5B illustrates an exemplary discrimination data table (before correction).

FIG. 5C illustrates an exemplary discrimination data table (after correction).

### MODE FOR CARRYING OUT THE INVENTION

Hereinafter, an embodiment of the present invention is described in detail, with reference to the drawings. Identical or equivalent parts in the drawings are denoted by the same reference numerals, and the descriptions of the same are not repeated.

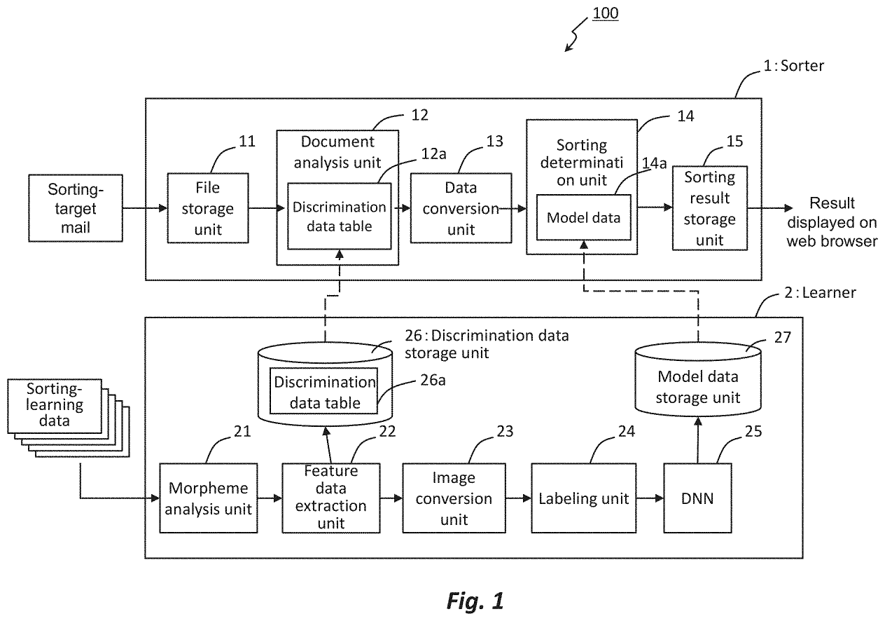

FIG. 1 is a block diagram illustrating a schematic configuration of a mail sorting system 100 according to the present embodiment. The mail sorting system 100 inputs text data of a subject and a body of a sorting-target mail, and sorts the sorting-target mail according to a predetermined purpose. The mail sorting system 100, however, does not perform the sorting simply depending on whether or not a predetermined word is contained in text data of a subject or a body of a mail, as is the case with the conventional mail sorting system, but performs the sorting with use of a learned model generated based on a large amount of data for learning.

It should be noted that the sorting categories used by the mail sorting system 100 are not limited particularly. A mail can be sorted with use of arbitrary categories, for example, degrees of urgency, degrees of importance, addresses (posts, or persons in charge), and subjects (request for quotation, order, request for repair, inquiry, complaint, etc.) Moreover, two-, three-, or more-dimensional sorting can be set. In other words, a sorting method can be used in which mails are sorted by addresses, and at the same time, the sorting result is further sorted by multiple phases such as degrees of urgency, degrees of importance, subjects, etc.

As illustrated in FIG. 1, the mail sorting system 100 includes a sorter 1 and a learner 2. The sorter 1 can be configured as, for example, a cloud system. The sorter 1 and the learner 2 do not have to be connected at all times.

The sorter 1 includes a file storage unit 11, a document analysis unit 12, a data conversion unit 13, a sorting determination unit 14, and a sorting result storage unit 15. The learner 2 includes a morpheme analysis unit 21, a feature data extraction unit 22, an image conversion unit 23, a labeling unit 24, a deep neural network (DNN) 25, a discrimination data storage unit 26, and a model data storage unit 27.

The document analysis unit 12 of the sorter 1 includes a discrimination data table 12a. The discrimination data table 12a holds a copy of a discrimination data table 26a generated by the learner 2 and stored in the discrimination data storage unit 26. The generation of discrimination data is described in detail below.

The sorting determination unit 14 of the sorter 1 holds model data 14a. The model data 14a are parameters of a learned model generated by the DNN 25 in the learner 2. The generation of model data 14a is also described in detail below.

Here, respective operations of the units of the learner 2 are described. The learner 2 inputs sorting-learning data (teacher data) as illustrated in FIG. 1, causing the DNN 25 to learn, thereby generating model data. In other words, the morpheme analysis unit 21, the feature data extraction unit 22, the image conversion unit 23, and the labeling unit 24 are blocks for generating data suitable for the learning by the DNN 25.

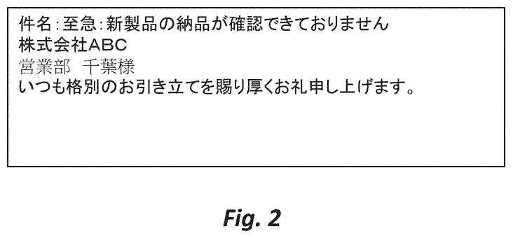

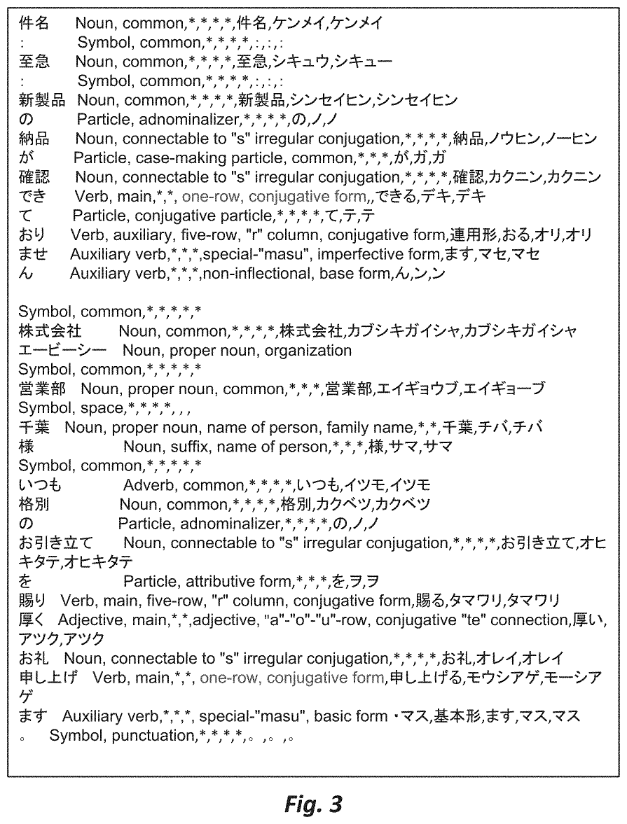

The sorting-learning data are text data of various mails. The morpheme analysis unit 21 performs morpheme analysis on text data of sorting-learning data, to cut out morphemes contained in the text data, and to identify the parts of speech of the morphemes. For example, when sorting-learning data shown in FIG. 2 are input, a result of the analysis performed by the morpheme analysis unit 21 are those as shown in FIG. 3 Incidentally, in the example shown in FIGS. 2 and 3, the subject and the text data of the body of the Email are combined and are analyzed as a target of analysis. To include not only the body of an Email but also the subject thereof in a target of analysis in this way is not essential, but is desired. This is because, when a mail relating to an important matter or an urgent matter is sent, a word indicating the degree of importance or urgency is often included in the subject of the Email.

Incidentally, FIGS. 2, 3, 4A and 4B illustrate an exemplary processing operation in Japanese. The scheme of morpheme analysis can possibly vary with languages. For example, in an English sentence, words are clearly separated by a space character, and there are relatively fewer variations of conjugations, which makes it relatively easy to cut out morphemes from text data. On the other hand, in a case of Japanese, Chinese, or the like, a break between phrases or words is not clearly shown in text data, which makes it necessary to distinguish a word boundary while performing matching with a dictionary. As the scheme of the morpheme analysis, however, arbitrary known schemes suitable for languages can be used, respectively, and detailed description is omitted here.

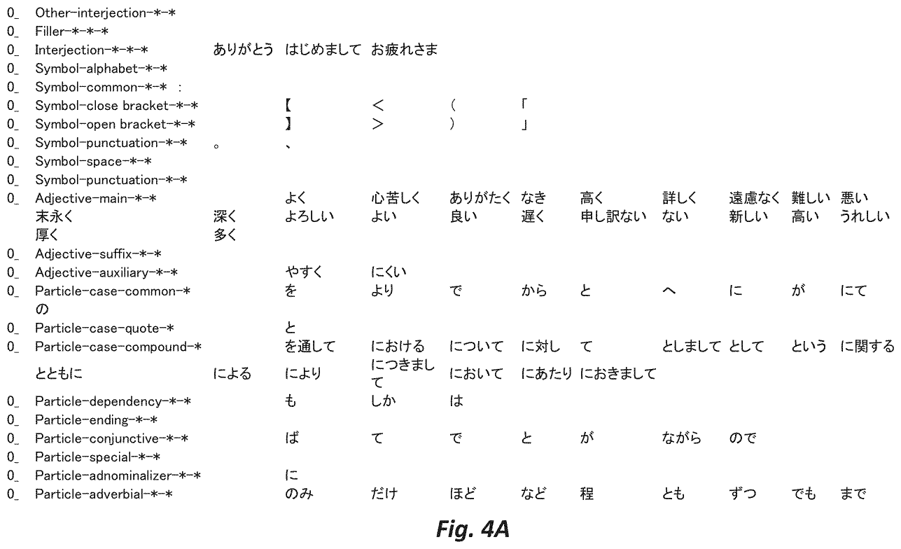

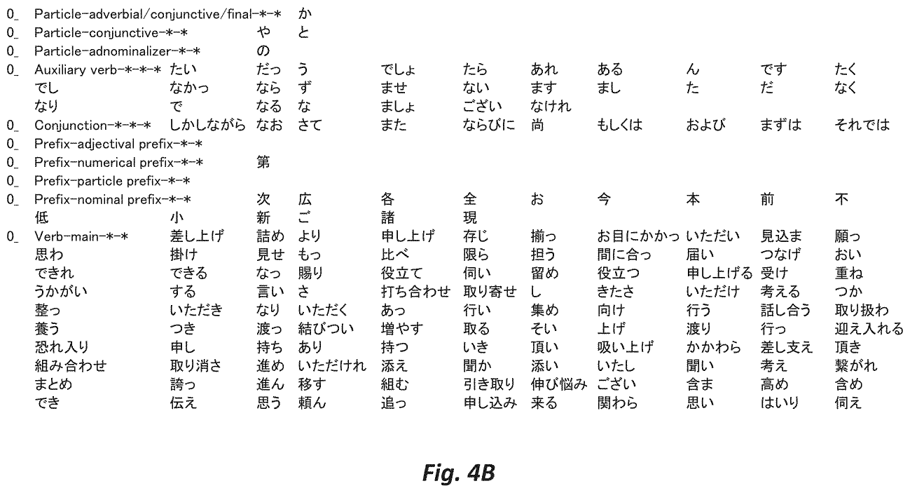

The feature data extraction unit 22 extracts feature data from the result of analysis performed by the morpheme analysis unit 21, and stores the extracted feature data into the discrimination data table 26a of the discrimination data storage unit 26. Here, in FIGS. 4A and 4B, an exemplary discrimination data table 26a composed of feature data is illustrated. Incidentally, FIG. 4B is continued from FIG. 4A. Those illustrated in FIGS. 4A and 4B are a small fraction of the discrimination data table. The feature data extraction unit 22 extracts, as feature data, a part of the result (morphemes) of analysis performed by the morpheme analysis unit 21, according to predetermined rules (for example, a frequency of appearance in sorting-learning data), sorts the extracted feature data by parts of speech, and stores the same into the discrimination data table 26a, as illustrated in FIGS. 4A and 4B. Incidentally, here, a part of morphemes are extracted as feature data, but alternatively, all of the morphemes may be stored in the discrimination data table.

The discrimination data table 26a, as illustrated in FIGS. 4A and 4B, contains morphemes extracted from sorting-learning data, in a state of being sorted by parts of speech and arrayed. In the case of the discrimination data table 26a illustrated in FIGS. 4A and 4B, the head of each row header is represented by “0_”. Following the above-described head symbol of “0”, the row header includes a description of the type of part of speech, and is followed by a morpheme (feature data) corresponding to the type of part of speech. In a case where a plurality of morphemes are contained in one row header, the morphemes are separated by a space symbol. Incidentally, another symbol than the space symbol may be used as a break symbol. For example, in the third row from the top in FIG. 4A, with a row header of the type of part of speech of “Interjection-*-*-*”, three morphemes (feature data) of [symbol] (Arigato)”, [symbol] [symbol] (Hajimemashite)”, and [symbol] (Otsukaresama)” are stored. Incidentally, the example illustrated in FIGS. 4A and 4B is a small fraction of morphemes stored in the discrimination data table. Actually, many other parts of speech (for example, proper nouns, etc.) are also stored in the discrimination data table 26a.

The image conversion unit 23 converts the result of analysis performed by the morpheme analysis unit 21 on each set of the sorting-learning data, into a binary image (an image for learning), based on the discrimination data table 26a of the discrimination data storage unit 26. Here, the image conversion unit 23 generates an image for learning having m rows×n columns of squares based on the discrimination data table 26a. Incidentally, both “m” and “n” are natural numbers. Each of m×n squares corresponds to one row header in the discrimination data table 26a. The values of m and n are set so that the value of m×n is greater than the expected number of row headers. The correspondence relation between the respective squares of the image for learning and the row headers of the discrimination data table 26a is arbitrary, on the condition that one square is assigned to one row header.

The image conversion unit 23 displays, in either white or black (e.g., in white), a square corresponding to a row header for a row containing a morpheme contained in a certain set of sorting-learning data, and displays the other squares in the other color (e.g., in black). For example, in a case where a morpheme of [symbol] (Arigato)” is contained in certain sorting-learning data, one square in the squares of an image for learning corresponding to the row header of the type of part of speech of “Interjection-*-*-*” is displayed in white. Similarly, all of squares corresponding to the row headers of rows containing the morphemes contained in the sorting-learning data are displayed in white. In this way, the image conversion unit 23 converts certain sorting-learning data into an image for learning as a binary image. The image conversion unit 23 performs this converting operation with respect to all sets of sorting-learning data, thereby generating images for learning in the same number as the number of sets of sorting-learning data. Further, the image conversion unit 23 may derivatively generate a large number of images for learning by changing a part of squares of the generated image for learning. For example, a derivative image for learning is generated by replacing one or several squares among those displayed in white with squares displayed in black, in the m rows×n columns of squares of a set of sorting-learning data. Incidentally, an image for learning derivatively generated herein is labeled with the same label (described below) as that of the original image for learning from which the derivative image for learning is generated. This makes it possible to easily generate a large number of images for learning based on a limited number of sets of sorting-learning data.

Incidentally, in the above-described configuration, squares corresponding to row headers of rows containing morphemes extracted from sorting-learning data are displayed in white, and the other squares are displayed in black. The display form of an image for learning, however, is not limited to such a binary display. For example, regarding morphemes contained in one row of a row header, based on the appearance frequencies thereof in sorting-learning data, squares corresponding thereto may be displayed in gray scales of three or more levels, or a plurality of colors such as red, green, and blue (RGB).

The labeling unit 24 labels respective images for learning generated from sets of sorting-learning data with labels indicating sorting types (categories) of original sorting-learning data, as meta data, for example. Category types can be arbitrarily set according to a desired sorting result. For example, categories such as “urgent”, “with a due date”, “without a due date”, etc. may be set according to the degree of urgency of a mail. Alternatively, categories such as “request for quotation”, “order”, “complaint”, “request for repair”, “advertisement”, “inquiry”, etc. may be set according to contents (subject) of a mail. Still alternatively, categories such as “important”, “ordinary”, etc. may be set according to the degree of importance of a mail.

The deep neural network (DNN) 25 reads labeled images for learning to perform a learning operation. In other words, in the present embodiment, the learning by the DNN 25 is so-called learning-with-teacher. The DNN 25 is given a multiplicity of images for learning so as to learn relevance between features of images for learning and sorting results (labels), thereby generating a learned model. When the learning is completed, parameters that define the generated learned model are stored in the model data storage unit 27.

As described above, the learner 2 generates a discrimination data table and model data, based on the sorting-learning data. The discrimination data table is generated only by extraction of feature data from a morpheme analysis result of sorting-learning data, without learning. Therefore, the discrimination data table can be more easily generated than model data.

Next, the configuration and function of the sorter 1 is described. The sorter 1 sorts a mail by using the discrimination data table and model data generated by the learner 2.

In the sorter 1, the file storage unit 11 inputs text data of a subject and a body of a sorting-target mail, and at least temporarily stores the same. In a case where the sorter 1 is configured as a cloud system, the file storage unit 11 receives sorting-target mails uploaded from a user-side system and stores the same. Sorting-target mails are uploaded at arbitrary timings (at an arbitrary frequency). Generally, text data files of mails are locally stored in a user-side system (mail server, etc.), and the text data files locally stored may be uploaded to the file storage unit 11 at an appropriately timing. After the sorting-target mails thus input are stored in the file storage unit 11, the sorter 1 may sort the sorting-target mails one by one by real-time processing. Or alternatively, among the sorting-target mails thus input, a predetermined number of the same, or a part of the same for a predetermined time, may be stored in the file storage unit 11, and thereafter, the sorter 1 may sort the mails by batch processing.

In the document analysis unit 12, a copy of the discrimination data table 26a read out of the discrimination data storage unit 26 of the learner 2 is stored as the discrimination data table 12a. Incidentally, as described above, the sorter 2 and the learner 1 do not have to be connected at all times. The discrimination data table 12a, once stored, can remain used continuously. In a case where the updating of the discrimination data table 12a is required for some reasons, however, in the learner 2, the discrimination data table 26a may be corrected in the discrimination data storage unit 26, and the corrected discrimination data table 26a may be overwritten on the discrimination data table 12a in the document analysis unit 12 of the sorter 1. A specific example of correction processing is described below. Alternatively, only the discrimination data table 12a in the document analysis unit 12 in the sorter 1 may be corrected.

The document analysis unit 12 refers to the discrimination data table 12a, and identifies a word (morpheme) contained in the sorting-target mail, among the words (morphemes) contained in the discrimination data table 12a. The data conversion unit 13 performs a similar processing operation as that of the image conversion unit 23 of the learner 2, and converts the sorting-target mail into a binary image (image for determination). In other words, the image conversion unit 23 displays squares as follows: in the image for determination having m rows and n columns of squares, squares corresponding to row headers of rows containing words (morphemes) contained the sorting-target mail, among the row headers of the discrimination data table 12a, are displayed in white, and the other squares are displayed in black.

The sorting determination unit 14, using the model data 14a, determines which category the image for determination obtained by the data conversion unit 13 corresponds to. the determination result is at least temporarily stored in the sorting result storage unit 15. The determination result stored in the sorting result storage unit 15 is presented to a user through a web browser, in the example shown in FIG. 1. The user of the sorter 1 can confirm mails sorted by categories through a web browser on an arbitrary terminal such as a computer, a tablet, or a smartphone. Incidentally, an arbitrary display method can be used for displaying the sorting result through a web browser. Desirably, mails are grouped by categories, and, for example, tags are attached to, or different colors are given to, mails with high degrees of urgency or importance so that the mails are noticeable. Incidentally, in the example shown in FIG. 1, the sorting result is displayed through a web browser. The method for displaying the determination result to a user, however, is not limited to this.

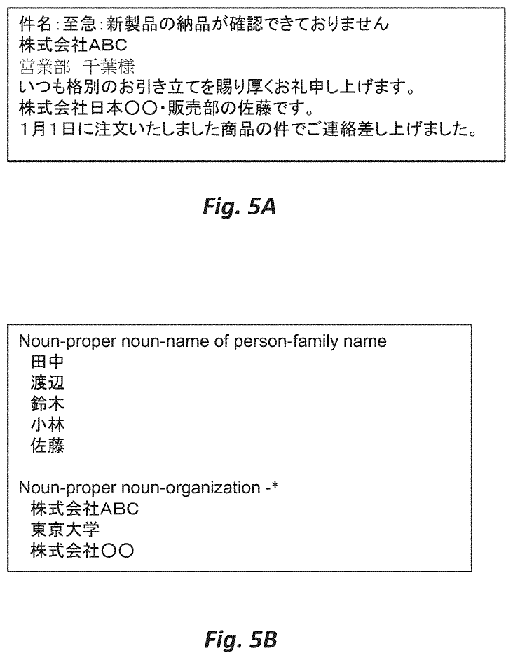

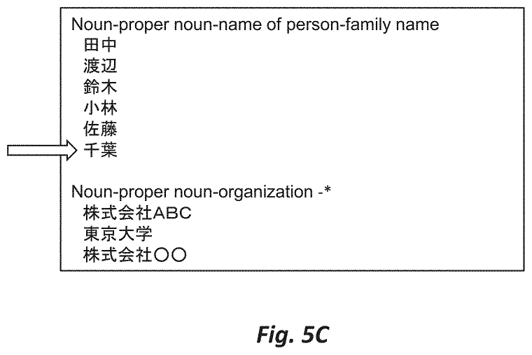

Here, a specific example of correction of the discrimination data table 12a in the sorter 1 is described. For example, in a case where a sorting result output from the sorter 1 and displayed through a web browser while the sorter 1 is being used is not a result that a user desires, a new morpheme can be added to the discrimination data table 12a in the sorter 1. For example, in a case where a mail as shown in FIG. 5A is not sorted in a desired category (for example, in a case where the mail, which should have been sorted into a category of “Important”, is actually sorted in a category of “Others”), the reason is that the morpheme of [symbol] (Chiba)” is not stored in the row of the row header of “Noun-proper noun-name of person-family name”, as illustrated in FIG. 5B. More specifically, when the learning is performed by the learner 2, if this morpheme of [symbol] (Chiba)” is not contained in any sorting-learning data (in other words, the sorting-target mail contains a first-sight morpheme of [symbol] (Chiba)”), the image for determination generated by the data conversion unit 13 is a binary image that does not reflect the presence of the morpheme of [symbol] (Chiba)” correctly, resulting in that an intended sorting result cannot be obtained. In this case, by adding [symbol] (Chiba)” in the row of the row header of “Noun-proper noun-name of person-family name” in the discrimination data table 12a as indicated by an arrow in FIG. 5C, a correct image for determination that reflects the presence of the morpheme of [symbol] (Chiba)” in the sorting-target mail is generated by the data conversion unit 13, resulting in that the mail shown in FIG. 5A is sorted in a correct category (“Important”).

Incidentally, in this case, the operation of adding [symbol] (Chiba)” to the discrimination data table 12a may be automatically by the morpheme analysis unit 21 and the feature data extraction unit 22 of the learner 2. However, the foregoing operation does not necessarily have to go through the operation by the morpheme analysis unit 21 and the feature data extraction unit 22 of the learner 2. For example, as shown in FIG. 5C, text data of [symbol] (Chiba)” are simply inserted into the discrimination data table 12a by a hand.

Besides, it is not essential that the regeneration (correction) of the model data 14a by the learner 2 should be performed after the discrimination data table 12a is corrected. The mail sorting system 100 of the present embodiment is rather characterized in that the discrimination accuracy can be improved only by correcting the discrimination data table 12a, without regeneration (correction) of model data 14a.

In other words, by correcting the discrimination data table 12a, a correct binary image is generated from the sorting-target mail by the data conversion unit 13 after the correction. As described above, the correction of the discrimination data table 12a can be performed relatively easily by insertion or deletion of text data. In contrast, in a case of the regeneration of model data 14a, reading a large amount of sorting-learning data is required to perform the operation. This is beyond a simple correction operation. In other words, whereas the regeneration of model data 14a cannot be performed frequently, the correction of the discrimination data table 12a may be merely a simple customizing operation, and therefore can be appropriately executed as required, on each of such occasions as feedback of missorting by a user. With the mail sorting system 100 of the present embodiment, therefore, it is possible to perform an advanced sorting operation using a learned model (model data 14a), and in addition to this, it is possible to correct missorting only with simple correction of the discrimination data table 12a. Thus, excellent effects are achieved.

Incidentally, the above description describes an example in which a morpheme is added to the discrimination data table 12a, but one aspect of correction also encompasses deleting an unnecessary morpheme from the discrimination data table 12a, and rewriting a stored morpheme.

As described above, one embodiment of the present invention is described, but the embodiment described above is merely an example and does not limit the present invention. For example, in the above-described embodiment, the generation of a learned model by a learning-with-teacher method is described as an example, but a learned model may be generated by a learning-without-teacher method. In this case, the labeling unit 24 is omitted.

Further, a part or an entirety of the functional blocks of the above-described embodiment may be implemented by a program. Then, a part or an entirety of processing operations of each functional block of the above-described embodiment is performed by a central processing unit (CPU), a microprocessor, a processor, or the like in a computer. Further, the programs for performing respective processing operations are stored in a storage device such as a hard disk or a read-only memory (ROM), and is read out by a ROM or a random access memory (RAM) so as to be executed.

Still further, each processing operation in the embodiments described above may be implemented by hardware, or alternatively, may be implemented by software (which encompasses the implementation with an operating system (OS), middleware, or a predetermined library). Still further, the mail sorting system 100 may be implemented by mixture of processing operations of software and hardware.

In addition, the execution order of the operations in the processing method in the above-described embodiment is not limited by the description of the above-described embodiment. The execution order can be changed without departing from the spirit and scope of the invention. Further, in the processing method in the above-described embodiment, a part of the steps may be executed in parallel with other steps without departing from the spirit and scope of the invention.

A computer program causing a computer to execute the above-described method, and a computer-readable recording medium that stores the program are encompassed in the scope of the present invention. Here, the type of the computer-readable recording medium is arbitrary. In addition, the above-described computer program is not limited to that recorded in the recording medium, but may be transmitted via an electric communication channel, a wireless or wired communication channel, a network typified by the Internet, or the like.

It should be noted that a specific configuration of the present invention is not limited to the above-described embodiment, but can be variously modified and corrected without departing from the spirit and scope of the invention.

The present invention can also be described as follows.

A mail sorting device according to a first configuration of the present invention includes:
a storage unit that inputs text data of a sorting-target mail and at least temporarily stores the text data;
a discrimination data table that stores morphemes that can be contained in text data of a mail for every part of speech;
an analysis unit that refers to the discrimination data table, and identifies which morpheme, among the morphemes stored in the discrimination data table, is contained in the sorting-target mail;
a data conversion unit that, based on a result of a processing operation performed by the analysis unit, generates an image for determination that represents distribution of morphemes contained in the sorting-target mail, among the morphemes stored in the discrimination data table; and
a sorting determination unit that determines in which category the sorting-target mail is to be sorted, based on a learned model that has learned a correlation between an image for determination and a sorting-target mail category.

In this first configuration, a discrimination data table that stores morphemes that can be contained in text data of a mail for every part of speech, and an image for determination is generated that represents distribution of morphemes contained in the sorting-target mail, among the morphemes stored in the discrimination data table. Then, in which category the sorting-target mail is to be sorted is determined based on a learned model that has learned correlations between images for determination and sorting-target mail categories. With this configuration, the category determination can be more appropriately carried out on mails, by complicated and comprehensive determination criteria achieved by using a learned model, as compared with a conventional case where mails are sorted depending simply on whether or not a predetermined word or sentence is contained.

A mail sorting device according to the second configuration of the present invention is the mail sorting device according to the first configuration further characterized in that a new morpheme can be added to the discrimination data table, a morpheme stored in the discrimination data table can be deleted therefrom, or a morpheme stored in the discrimination data table can be overwritten.

With this second configuration, in a case of a missorting of a mail, the discrimination data table can be updated by, for example, newly adding a morpheme contained in text data of the missorted mail to the discrimination data table. This makes it possible to correct missorting only by a relatively easy operation of updating of the discrimination data table, without regeneration of a learned model.

A mail sorting device according to the third configuration of the present invention is the mail sorting device according to the first or second configuration further characterized in that the sorting-target mail category includes at least one of a degree of urgency, a degree of importance, an address, and a subject.

A mail sorting method according to the present invention is
a mail sorting method executed by a computer, the method including:
inputting text data of a sorting-target mail and at least temporarily storing the text data;
referring to a discrimination data table storing morphemes that can be contained in text data of a mail for every part of speech, and identifying which morpheme, among the morphemes stored in the discrimination data table, is contained in the sorting-target mail;
generating an image for determination that represents distribution of morphemes contained in the sorting-target mail, among the morphemes stored in the discrimination data table; and
determining in which category the sorting-target mail is to be sorted, based on a learned model that has learned a correlation between an image for determination and a sorting-target mail category.

According to this mail sorting method, a discrimination data table storing morphemes that can be contained in text data of a mail for every part of speech is referred to, and an image for determination is generated that represents distribution of morphemes contained in the sorting-target mail, among the morphemes stored in this discrimination data table. Then, in which category the sorting-target mail is to be sorted is determined based on a learned model that has learned correlations between images for determination and sorting-target mail categories. With this configuration, the category determination can be more appropriately carried out on mails, by complicated and comprehensive determination criteria achieved by using a learned model, as compared with a conventional case where mails are sorted depending simply on whether or not a predetermined word or sentence is contained.

A program according to the present invention is a program for causing a computer to execute processing including:
inputting text data of a sorting-target mail and at least temporarily storing the text data;
referring to a discrimination data table storing morphemes that can be contained in text data of a mail for every part of speech, and identifying which morpheme, among the morphemes stored in the discrimination data table, is contained in the sorting-target mail;
generating an image for determination that represents distribution of morphemes contained in the sorting-target mail, among the morphemes stored in the discrimination data table; and
determining in which category the sorting-target mail is to be sorted, based on a learned model that has learned a correlation between an image for determination and a sorting-target mail category.

A computer that is caused to operate by this program refers to a discrimination data table storing morphemes that can be contained in text data of a mail for every part of speech, and generates an image for determination that represents distribution of morphemes contained in the sorting-target mail, among the morphemes stored in this discrimination data table. Then, the computer determines in which category the sorting-target mail is to be sorted, based on a learned model that has learned correlations between images for determination and sorting-target mail categories. With this configuration, the category determination can be more appropriately carried out on mails, by complicated and comprehensive determination criteria achieved by using a learned model, as compared with a conventional case where mails are sorted depending simply on whether or not a predetermined word or sentence is contained.

In addition, a recording medium that stores the above-described program is also one aspect of the present invention.

A learned model generation device according to the present invention includes:
a discrimination data table that stores morphemes that can be contained in text data of a mail for every part of speech;
a morpheme analysis unit that performs morpheme analysis on text data for learning;
a feature data extraction unit that extracts morphemes to be stored in the discrimination data table, from a result of the analysis performed by the morpheme analysis unit, according to a predetermined rule, and stores the extracted morphemes into the discrimination data table;
an image conversion unit that generates an image for learning that represents distribution of morphemes contained in the text data for learning, among the morphemes stored in the discrimination data table; and
a learning unit for generating a learned model that has learned a correlation between an image for learning and a result of sorting of text data for learning.

This learned model generation device uses, as learning data, an image for learning that represents distribution of morphemes contained in text data for learning, among the morphemes stored in this discrimination data table that stores morphemes that can be contained in text data of a mail for every part of speech. This enables efficient learning of a lot of learning data including a wide variety of morphemes, as compared with a case where text data of mails are learned as is. As a result, it is possible to generate a learned model that can output highly reliable determination result regarding a correlation between text data of a mail and a result of sorting of the same.

A learned model generation method according to the present invention is a learned model generation method that includes:
performing morpheme analysis on text data for learning;
extracting morphemes to be stored in the discrimination data table, from a result of the morpheme analysis, according to a predetermined rule, and stores the extracted morphemes into the discrimination data table for every part of speech;
an image conversion unit that generates an image for learning that represents distribution of morphemes contained in the text data for learning, among the morphemes stored in the discrimination data table; and
generating a learned model that has learned a correlation between an image for learning and a result of sorting of text data for learning.

This learned model generation method uses, as learning data, an image for learning that represents distribution of morphemes contained in text data for learning, among the morphemes stored in this discrimination data table that stores morphemes that can be contained in text data of a mail for every part of speech. This enables efficient learning of a lot of learning data including a wide variety of morphemes, as compared with a case where text data of mails are learned as is. As a result, it is possible to generate a learned model that can output highly reliable determination result regarding a correlation between text data of a mail and a result of sorting of the same.

### DESCRIPTION OF REFERENCE SYMBOLS

100: mail sorting system
1: sorter
2: learner
11: file storage unit
12: document analysis unit
13: data conversion unit
14: sorting determination unit
15: sorting result storage unit
21: morpheme analysis unit
22: feature data extraction unit
23: image conversion unit
24: labeling unit
25: deep neural network (DNN)
26: discrimination data storage unit
27: model data storage unit

1. A mail sorting device comprising:
a storage unit that inputs text data of a sorting-target mail and at least temporarily stores the text data;
a discrimination data table that stores morphemes that can be contained in text data of a mail for every part of speech;
an analysis unit that refers to the discrimination data table, and identifies which morpheme, among the morphemes stored in the discrimination data table, is contained in the sorting-target mail;
a data conversion unit that, based on a result of a processing operation performed by the analysis unit, generates an image for determination that represents distribution of morphemes contained in the sorting-target mail, among the morphemes stored in the discrimination data table; and
a sorting determination unit that determines in which category the sorting-target mail should be sorted, based on a learned model that has learned a correlation between an image for determination and a sorting-target mail category.

2. The mail sorting device according to claim 1,
wherein a new morpheme can be added to the discrimination data table, any of the morphemes stored in the discrimination data table can be deleted therefrom, or any of the morphemes stored in the discrimination data table can be overwritten.

3. The mail sorting device according to claim 1,
wherein the sorting-target mail category includes at least one of a degree of urgency, a degree of importance, an address, and a subject of a mail.

4. A mail sorting method executed by a computer, the method comprising:
inputting text data of a sorting-target mail and at least temporarily storing the text data;
referring to a discrimination data table storing morphemes that can be contained in text data of a mail for every part of speech, and identifying which morpheme, among the morphemes stored in the discrimination data table, is contained in the sorting-target mail;
generating an image for determination that represents distribution of morphemes contained in the sorting-target mail, among the morphemes stored in the discrimination data table; and
determining a category in which the sorting-target mail is to be sorted, based on a learned model that has learned a correlation between an image for determination and a sorting-target mail category.

5. (canceled)

6. A non-transitory recording medium that stores a program for causing a computer to execute processing comprising:
inputting text data of a sorting-target mail and at least temporarily storing the text data;
referring to a discrimination data table storing morphemes that can be contained in text data of a mail for every part of speech, and identifying which morpheme, among the morphemes stored in the discrimination data table, is contained in the sorting-target mail;
generating an image for determination that represents distribution of morphemes contained in the sorting-target mail, among the morphemes stored in the discrimination data table; and
determining in which category the sorting-target mail is to be sorted, based on a learned model that has learned a correlation between an image for determination and a sorting-target mail category.

7. A learned model generation device comprising:
a discrimination data table that stores morphemes that can be contained in text data of a mail for every part of speech;
a morpheme analysis unit that performs morpheme analysis on text data for learning;
a feature data extraction unit that extracts morphemes to be stored in the discrimination data table, from a result of the analysis performed by the morpheme analysis unit, according to a predetermined rule, and stores the extracted morphemes into the discrimination data table;
an image conversion unit that generates an image for learning that represents distribution of morphemes contained in the text data for learning, among the morphemes stored in the discrimination data table; and
a learning unit for generating a learned model that has learned a correlation between an image for learning and a result of sorting of text data for learning.

8. A learned model generation method comprising:
performing morpheme analysis on text data for learning;
extracting morphemes to be stored in a discrimination data table, from a result of the morpheme analysis, according to a predetermined rule, and stores the extracted morphemes into the discrimination data table for every part of speech;
generating an image for learning that represents distribution of morphemes contained in the text data for learning, among the morphemes stored in the discrimination data table; and
generating a learned model that has learned a correlation between an image for learning and a result of sorting of text data for learning.
